(19) United States
(12) Patent Application Publication
(10) Pub. No.: US 2025/0216726 A1
(43) Pub. Date: Jul. 3, 2025

(54) OPTICAL PANEL

(71) Applicant: TIANMA JAPAN, LTD., Kawasaki (JP)

(72) Inventors: Atsushi YAMAMOTO, Kawasaki (JP); Tetsushi SATO, Kawasaki (JP); Yukie KEICHO, Kawasaki (JP)

(73) Assignee: TIANMA JAPAN, LTD., Kawasaki (JP)

(21) Appl. No.: 18/965,010

(22) Filed: Dec. 2, 2024

(30) Foreign Application Priority Data
Dec. 28, 2023 (JP) 2023-222810

(51) Int. Cl. G02F 1/1343; G02F 1/167; G02F 1/1676

(52) U.S. Cl. CPC G02F 1/134309; G02F 1/167; G02F 1/1676

(57) ABSTRACT

An optical panel includes a first light-transmitting substrate, a second light-transmitting substrate, and a liquid crystal or an electrophoretic medium sandwiched by the first light-transmitting substrate and the second light-transmitting substrate. The optical panel is installed with a front surface including a variable region inclined with respect to the ground surface. When applying voltage to a liquid crystal or an electrophoretic medium to set the variable region to one of two states, a voltage, higher than the voltage applied to the liquid crystal or the electrophoretic medium of an upper region positioned vertically upward in the variable region, is applied to the liquid crystal or the electrophoretic medium of at least a partial region of a lower region positioned vertically downward in the variable region.

### CROSS-REFERENCE TO RELATED APPLICATIONS

This application claims the benefit of Japanese Patent Application No. 2023-222810, filed on Dec. 28, 2023, the entire disclosure of which is incorporated by reference herein.

### FIELD OF THE INVENTION

The present application relates generally to an optical panel.

### BACKGROUND OF THE INVENTION

Display panels, spatial modulation elements, light control elements, and the like that use a liquid crystal or an electrophoretic medium (light-transmitting dispersion medium and electrophoretic particles) are known in the related art. In these optical panels, the liquid crystal or the electrophoretic medium is sandwiched between light-transmitting substrates.

For example, when a liquid crystal display panel is installed perpendicular to a ground surface, the liquid crystal is biased to a vertically downward side in the liquid crystal display panel due to gravity, and the cell thickness of the vertically downward side of the liquid crystal display panel is greater than the cell thickness of the vertically upward side of the liquid crystal display panel. When the cell thickness of the liquid crystal display panel is non-uniform, display inconsistencies occur in the liquid crystal display panel.

To address this, in Unexamined Japanese Patent Application Publication No. 2005-215113, the cell thickness is suppressed from becoming non-uniform by varying the elastic modulus per unit area of a spacer, that maintains the cell thickness, within the plane of the light-transmitting substrate (color filter substrate or array substrate).

In Unexamined Japanese Patent Application Publication No. 2005-215113, the elastic modulus per unit area of the spacer is varied within the plane of the light-transmitting substrate, and this complicates the manufacturing process of the liquid crystal display panel. Additionally, with elements in which the cell thickness is great such as liquid crystal lens elements and light control elements using an electrophoretic medium, it is difficult to improve the uniformity of the cell thickness by improving element structure.

### SUMMARY OF THE INVENTION

An optical panel according to a first aspect includes:
a first light-transmitting substrate;
a second light-transmitting substrate facing the first light-transmitting substrate; and
a liquid crystal or an electrophoretic medium including a light-transmitting dispersion medium and electrophoretic particles, sandwiched between the first light-transmitting substrate and the second light-transmitting substrate, wherein
a front surface including a variable region, in which an optical characteristic varies between two states throughout an entire surface, is installed inclined with respect to a ground surface,
in an installed state, the variable region is bisected into an upper region positioned vertically upward, and a lower region positioned vertically downward, and
in a case of applying a voltage to the liquid crystal or the electrophoretic medium to set the variable region to one state of the two states,
   a voltage, higher than a voltage applied to the liquid crystal or the electrophoretic medium of the upper region, is applied to the liquid crystal or the electrophoretic medium of at least a partial region of the lower region.

An optical panel according to a second aspect includes:
an electrophoretic medium including a light-transmitting dispersion medium and electrophoretic particles;
a first light-transmitting substrate and a second light-transmitting substrate sandwiching the electrophoretic medium; and,
a plurality of electrodes that applies a voltage to the electrophoretic medium, wherein
a front surface including a variable region, in which an optical characteristic varies between two states throughout an entire surface, is installed inclined with respect to a ground surface,
in an installed state, the variable region is bisected into an upper region positioned vertically upward, and a lower region positioned vertically downward, and
an arrangement pitch, of the electrodes disposed in at least a partial region of the lower region, is narrower than an arrangement pitch of the electrodes disposed in the upper region. It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a schematic drawing illustrating an optical panel, a liquid crystal display panel, and a display device according to Embodiment 1;

FIG. 2 is a cross-sectional view of the optical panel illustrated in FIG. 1, taken along line A-A;

FIG. 3 is a plan view illustrating a first driving electrode and a second driving electrode according to Embodiment 1;

FIG. 4 is a plan view illustrating a common electrode according to Embodiment 1;

FIG. 5 is a schematic drawing illustrating the arrangement of liquid crystal molecules according to Embodiment 1, in a second state;

FIG. 6 is a schematic drawing illustrating a cross-section of the optical panel according to Embodiment 1, in an installed state;

FIG. 7 is a drawing illustrating a potential of the first driving electrode or the second driving electrode according to a Comparative Example;

FIG. 8 is a drawing illustrating a retardation distribution in an upper region and a lower region according to the Comparative Example;

FIG. 9 is a drawing illustrating the potential of the first driving electrode or the second driving electrode according to Embodiment 1;

FIG. 10 is a drawing illustrating a retardation distribution in the upper region and the lower region according to Embodiment 1;

FIG. 11 is a plan view illustrating a first driving electrode and a second driving electrode according to Embodiment 2;

FIG. 12 is a schematic drawing illustrating a cross-section of the optical panel according to Embodiment 2, in an installed state;

FIG. 13 is a schematic drawing illustrating a cross-section of an optical panel according to Embodiment 3;

FIG. 14 is a schematic drawing illustrating a cross-section of the optical panel according to Embodiment 3, in an installed state;

FIG. 15 is a schematic drawing illustrating a dispersion state of electrophoretic particles according to Embodiment 3;

FIG. 16 is a plan view illustrating a third driving electrode and a fourth driving electrode according to Embodiment 4;

FIG. 17 is a plan view illustrating a third counter electrode and a fourth counter electrode according to Embodiment 4;

FIG. 18 is a schematic drawing illustrating a cross-section of an optical panel according to a modified example;

FIG. 19 is a drawing illustrating potentials of a driving electrode and common electrodes according to a modified example;

FIG. 20 is a plan view illustrating driving electrodes according to a modified example;

FIG. 21 is a plan view illustrating driving electrodes according to a modified example; and

FIG. 22 is a drawing for explaining the functions of an optical panel according to a modified example.

### DETAILED DESCRIPTION OF THE INVENTION

Hereinafter, an optical panel according to various embodiments is described while referencing the drawings.

### Embodiment 1

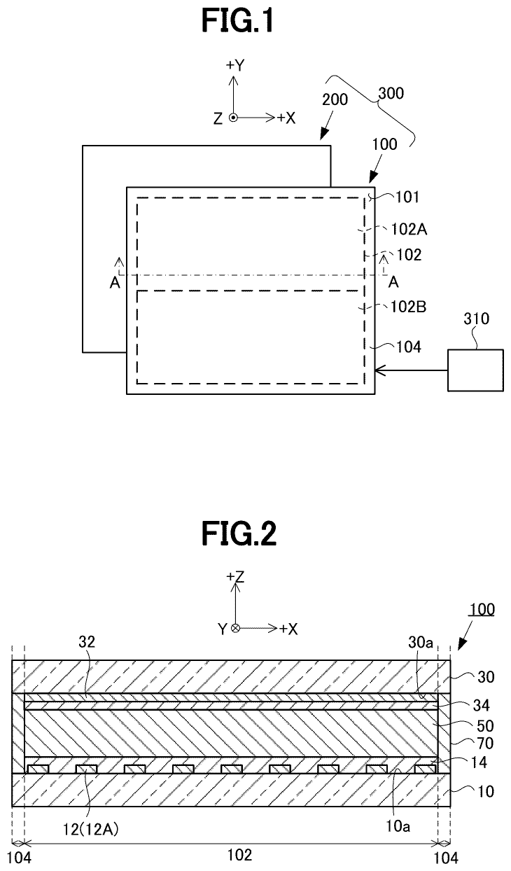

An optical panel 100 according to the present embodiment is described while referencing FIGS. 1 to 10. The optical panel 100 functions as a liquid crystal lens (liquid crystal light deflection element). For example, as illustrated in FIG. 1, the optical panel 100 is disposed on a display surface side of a liquid crystal display panel 200 and, together with the liquid crystal display panel 200, forms a display device 300 that displays two-dimensional images and three-dimensional images. Display light of the liquid crystal display panel 200 is linearly polarized light having a Y direction as the polarization direction.

The optical panel 100 (the display device 300) is installed with a front surface 101 perpendicular to a ground surface. In the present embodiment, to facilitate comprehension, a description is given in which a vertical direction is referred to as the “Y-axis direction”, a direction parallel to the ground surface and the front surface 101 of the optical panel 100 is referred to as the “X-axis direction”, and a front surface direction perpendicular to the X-axis direction and the Y-axis direction is referred to as the “Z-axis direction.” Additionally, when the optical panel 100 is installed, the +Y direction is upward and, as such, the +Y direction may also be referred to as upward or vertically upward, and the −Y direction may also be referred to as downward or vertically downward. These restrictions apply to the other embodiments as well.

The optical panel 100 includes a variable region 102 in which a refractive index distribution varies, and a surrounding region 104 that surrounds the variable region 102. In an installed state, the variable region 102 is bisected into an upper region 102A positioned vertically upward, and a lower region 102B positioned vertically downward. The variable region 102 varies between a state in which the refractive index distribution is uniform across the entire surface, and a state in which the refractive index distribution varies at a predetermined cycle along the X-axis direction. In the present embodiment, the state in which the refractive index distribution is uniform across the entire surface is referred to as a “first state”, and the state in which the refractive index distribution varies at a predetermined cycle along the X-axis direction is referred to as a “second state.”

When the variable region 102 of the optical panel 100 is in the first state, the display device 300 displays a two-dimensional image. When the variable region 102 of the optical panel 100 is in the second state, the optical panel 100 functions as a lenticular lens array in which cylindrical lenses extending in the Y-axis direction are arranged in the X-axis direction, and the display device 300 displays a three-dimensional image.

Next, a specific configuration of the optical panel 100 is described. As illustrated in FIG. 2, the optical panel 100 includes a first light-transmitting substrate 10, a second light-transmitting substrate 30, and a liquid crystal 50. The first light-transmitting substrate 10 and the second light-transmitting substrate 30 sandwich the liquid crystal 50.

The first light-transmitting substrate 10 transmits visible light. In one example, the first light-transmitting substrate 10 is implemented as a flat glass substrate. As illustrated in FIG. 2, the first light-transmitting substrate 10 includes a plurality of driving electrodes 12 and an alignment film 14.

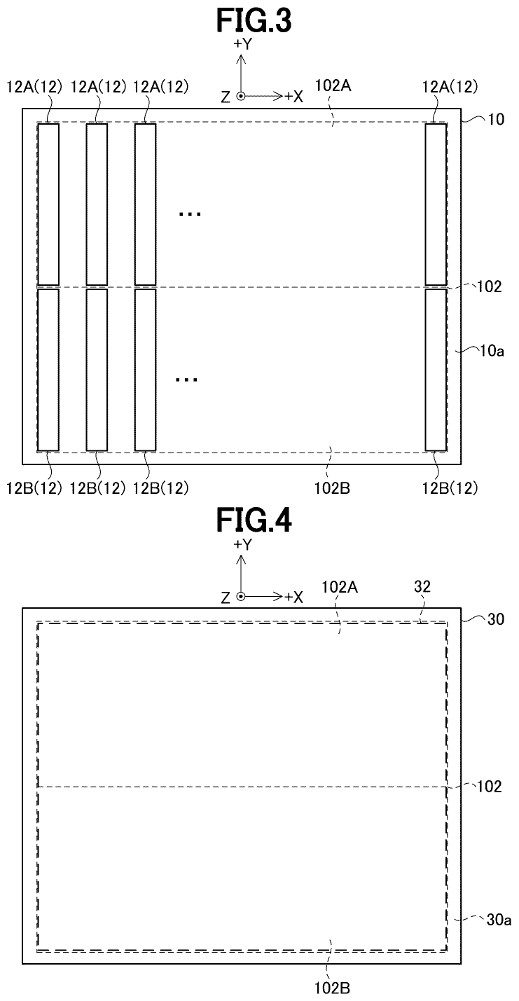

As illustrated in FIGS. 2 and 3, the driving electrodes 12 are provided on a main surface 10a of the liquid crystal 50 side of the first light-transmitting substrate 10. Each of the driving electrodes 12 has a rectangular shape and extends along the Y-axis direction. The driving electrodes 12 are disposed in the variable region 102 at a predetermined spacing in the X-axis direction. Each of the driving electrodes 12 is bisected into a first driving electrode 12A and a second driving electrode 12B.

Each of the first driving electrodes 12A has a rectangular shape. The first driving electrodes 12A extend along the Y-axis direction and are positioned in the upper region 102A of the variable region 102. Each of the second driving electrodes 12B has a rectangular shape. The second driving electrodes 12B extend along the Y-axis direction and are positioned in the lower region 102B of the variable region 102. The first driving electrodes 12A and the second driving electrodes 12B are arranged along the Y-axis direction. The first driving electrodes 12A and the second driving electrodes 12B are each connected to a controller 310 via a non-illustrated wiring. The driving electrodes 12 (the first driving electrodes 12A and the second driving electrodes 12B) are formed as conductive films that transmit visible light. In one example, the driving electrodes 12 are formed from indium tin oxide (ITO).

The alignment film 14 is provided on the main surface 10a, the first driving electrodes 12A, and the second driving electrodes 12B. The alignment film 14 aligns the liquid crystal 50 with the Y-axis direction. In one example, the alignment film 14 is implemented as a polyimide alignment film that has been subjected to an alignment treatment.

The second light-transmitting substrate 30 transmits visible light. In one example, the second light-transmitting substrate 30 is implemented as a flat glass substrate. As illustrated in FIG. 2, the second light-transmitting substrate 30 faces the first light-transmitting substrate 10. The second light-transmitting substrate 30 is affixed to the first light-transmitting substrate 10 by a sealing material 70. The second light-transmitting substrate 30 includes a common electrode 32 and an alignment film 34.

The common electrode 32 is provided on the main surface 30a of the liquid crystal 50 side of the second light-transmitting substrate 30. As illustrated in FIGS. 2 and 4, the common electrode 32 is formed in a rectangular shape. The common electrode 32 faces the first driving electrodes 12A and the second driving electrodes 12B. The common electrode 32 is connected to the controller 310 via a non-illustrated wiring. The common electrode 32 is formed as a conductive film that transmits visible light. In one example, the common electrode 32 is formed from ITO.

The alignment film 34 is provided on the common electrode 32. The alignment film 34 aligns the liquid crystal 50 with the Y-axis direction. In one example, the alignment film 34 is implemented as a polyimide alignment film that has been subjected to an alignment treatment.

The liquid crystal 50 is sandwiched between the first light-transmitting substrate 10 and the second light-transmitting substrate 30. In one example, the liquid crystal 50 is implemented as a positive nematic liquid crystal. The liquid crystal 50 is aligned with the Y-axis direction by the alignment film 14 and the alignment film 34.

Next, operations of the optical panel 100 are described. The optical panel 100 functions as a lenticular lens array due to variations in the alignment of the liquid crystal 50.

In one example, when the potential of the driving electrodes 12 (the first driving electrodes 12A and the second driving electrodes 12B) of the first light-transmitting substrate 10 and the potential of the common electrode 32 of the second light-transmitting substrate 30 are set to the same potential (for example, ground potential) by the controller 310, voltage is not applied to the liquid crystal 50 and, as such, the liquid crystal 50 maintains the alignment with the Y-axis direction. In such a case, the variable region 102 is in a state in which the refractive index distribution is uniform across the entire surface (that is, the first state), and the optical panel 100 does not function as a lenticular lens array.

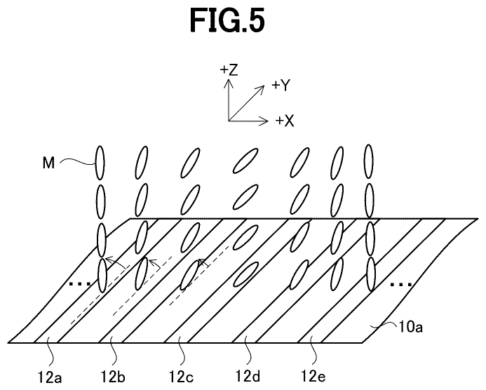

Meanwhile, when the potential of the common electrode 32 is set to ground potential, and the potential of the driving electrodes 12a to 12e arranged in the X-axis direction is increased in the order of driving electrodes 12a, 12e>driving electrodes 12b, 12d>driving electrode 12c, as illustrated in FIG. 5, a rise, relative to main surface 10a of the first light-transmitting substrate 10, of liquid crystal molecules M increases from the driving electrode 12c toward the driving electrode 12a or the driving electrode 12e. In such a case, the variable region 102 is in a state in which the refractive index distribution varies along the X axis direction at a predetermined cycle (that is, the second state), and the optical panel 100 functions as a lenticular lens array extending in the Y-axis direction and arranged in the X-axis direction.

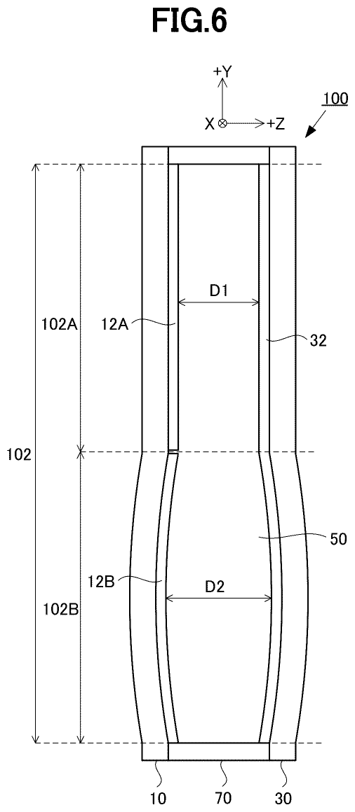

The optical panel 100 is installed with the front surface 101 including the variable region 102 perpendicular to the ground surface. Due to this, as illustrated in FIG. 6, the liquid crystal 50 is biased to the lower region 102B in the variable region 102 due to gravity, and a thickness (cell thickness) D2 of the liquid crystal 50 of the lower region 102B of the optical panel 100 is greater than a thickness D1 of the liquid crystal 50 of the upper region 102A of the optical panel 100. In cases in which the thickness D2 of the liquid crystal 50 of the lower region 102B is greater than the thickness D1 of the liquid crystal 50 of the upper region 102A, when the same voltage is applied to the liquid crystal 50 of the lower region 102B and the liquid crystal 50 of the upper region 102A, a difference in the focal distance (retardation) of the lenticular lens occurs between the upper region 102A and the lower region 102B. The difference between the focal distance of the upper region 102A and the focal distance of the lower region 102B causes a decline in the quality of the three-dimensional image displayed by the display device 300.

Note that, to facilitate comprehension, the alignment films 14 and 34, and the hatching of the various components are omitted from FIG. 6. The alignment films 14 and 34 and/or the hatching of the various components may be omitted from the following drawings as well.

As such, in the present embodiment, a voltage, higher than the voltage applied to the liquid crystal 50 of the upper region 102A by the common electrode 32 and the first driving electrodes 12A, is applied to the liquid crystal 50 of the lower region 102B by the common electrode 32 and the second driving electrodes 12B. As a result, it is possible to suppress inconsistencies in the optical characteristics of the upper region 102A and the lower region 102B (specifically, focal distance inconsistencies, retardation inconsistencies, and the like).

In the following, the distribution of the retardation R in the upper region 102A and the lower region 102B is described using, as an example, a case in which a single lenticular lens (lens pitch: 147 μm) is formed by 13 of the driving electrodes 12 (the first driving electrodes 12A and the second driving electrodes 12B) arranged along the X direction, with a refractive index anisotropy Δn of the liquid crystal 50 set to 0.2556, the thickness D1 of the liquid crystal 50 of the upper region 102A set to 50 μm, and the thickness D2 of the liquid crystal 50 of the lower region 102B set to 55 μm. The distribution of the retardation R is formed as a result of applying voltage to the liquid crystal 50 to cause, in the liquid crystal 50, a distribution of the refractive index anisotropy Δn relative to incident light (the display light of the liquid crystal display panel 200). In the present embodiment, as described above, the rise of the liquid crystal molecules M varies along the X-axis direction in accordance with the applied voltage and, as a result, a distribution of the refractive index anisotropy Δn relative to incident light is generated.

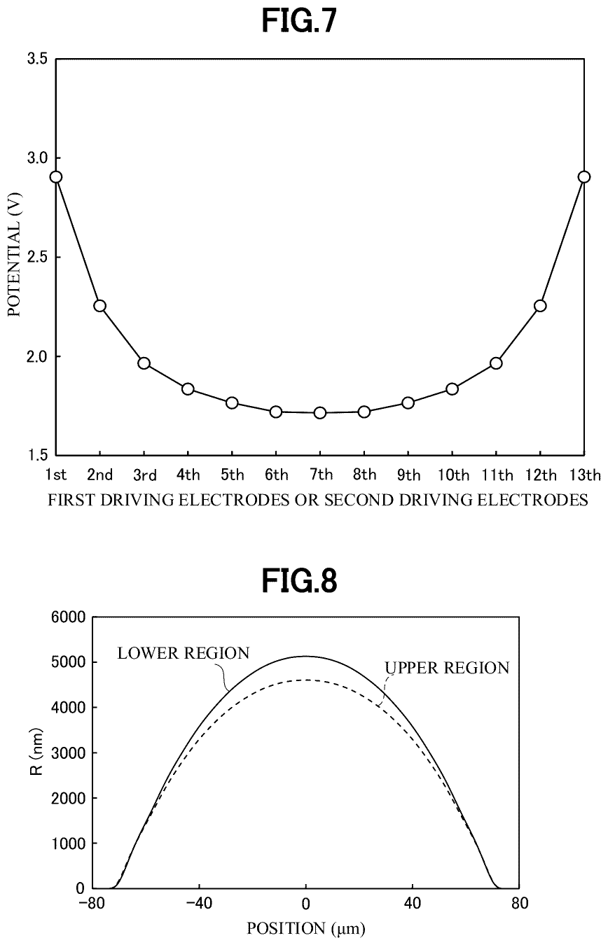

In a case (Comparative Example) in which the potential of the common electrode 32 is set to ground potential, and the potentials of the 1st to 13th first driving electrodes 12A or second driving electrodes 12B in order from the −X direction are controlled as illustrated in FIG. 7, thereby applying the same voltage to the liquid crystal 50 of the lower region 102B and to the liquid crystal 50 of the upper region 102A, as illustrated in FIG. 8, a difference (inconsistency) in the retardation R occurs between the upper region 102A and the lower region 102B.

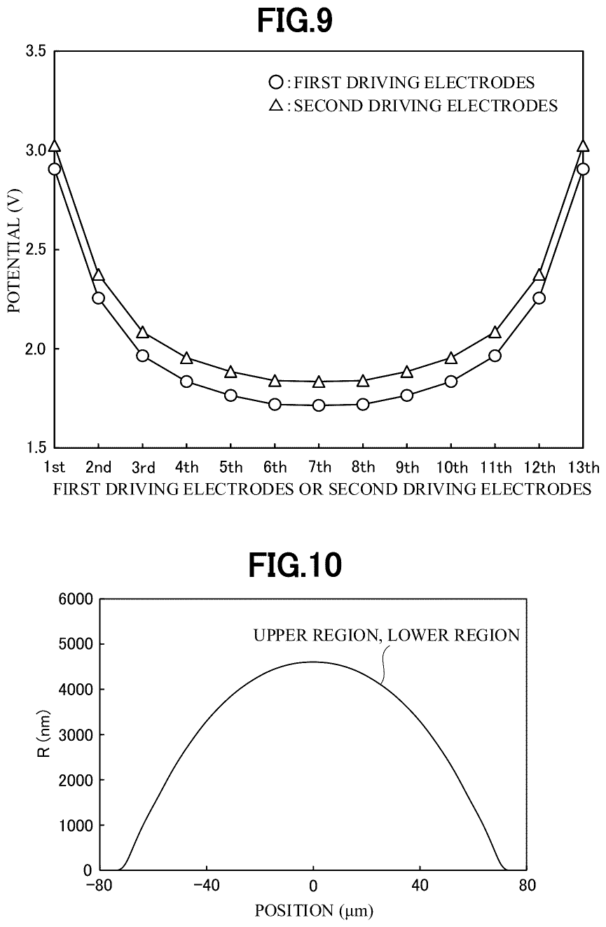

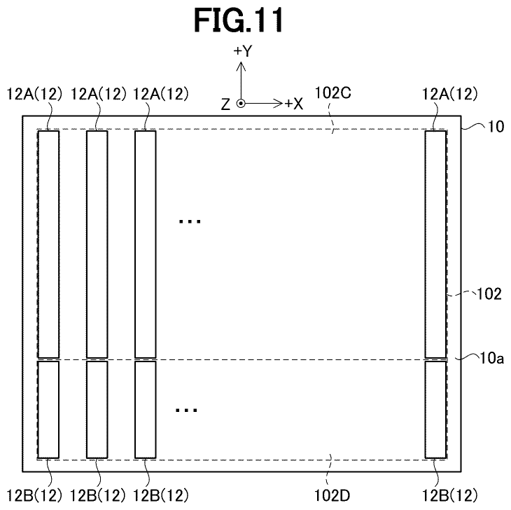

In the present embodiment, as illustrated in FIG. 9, the potential of the second driving electrodes 12B is controlled to be higher than the potential of the first driving electrodes 12A, and voltage higher than the voltage applied to the liquid crystal 50 of the upper region 102A is applied to the liquid crystal 50 of the lower region 102B. In this case, as illustrated in FIG. 10, the retardation R of the lower region 102B can be made to match the retardation R of the upper region 102A.

As described above, a voltage, higher than the voltage applied to the liquid crystal 50 of the upper region 102A, is applied to the liquid crystal 50 of the lower region 102B and, as such, it is possible to suppress inconsistencies in the optical characteristics of the upper region 102A and the lower region 102B.

### Embodiment 2

In Embodiment 1, a voltage, higher than the voltage applied to the liquid crystal 50 of the upper region 102A, is applied to the liquid crystal 50 of the lower region 102B. However, a configuration is possible in which, in the optical panel 100, a voltage, higher than the voltage applied to the liquid crystal 50 of the upper region 102A, is applied to the liquid crystal 50 of a partial region of the lower region 102B.

As with the optical panel 100 of Embodiment 1, an optical panel 100 of the present embodiment is installed with a front surface 101 perpendicular to the ground surface. Additionally, as with the optical panel 100 of Embodiment 1, the optical panel 100 of the present embodiment includes a variable region 102 and a surrounding region 104. The optical panel 100 of the present embodiment includes a first light-transmitting substrate 10, a second light-transmitting substrate 30, and a liquid crystal 50. The operations of the optical panel 100 and the configurations of the second light-transmitting substrate 30 and the liquid crystal 50 of the present embodiment are the same as in Embodiment 1 and, as such, the first light-transmitting substrate 10, and the region to which a voltage, higher than the voltage applied to the liquid crystal 50 of an upper region 102A, is applied are described.

As with the first light-transmitting substrate 10 of Embodiment 1, the first light-transmitting substrate 10 of the present embodiment includes a plurality of driving electrodes 12, and an alignment film 14. The configuration of the alignment film 14 is the same as in Embodiment 1.

As with the driving electrodes 12 of Embodiment 1, the driving electrodes 12 of the present embodiment are provided on a main surface 10a of the first light-transmitting substrate 10. Each of the driving electrodes 12 has a rectangular shape. The driving electrodes 12 of the present embodiment extend along the Y-axis direction, and are disposed at a predetermined spacing in the X-axis direction. The driving electrodes 12 of the present embodiment are divided into two sections, first driving electrodes 12A and second driving electrodes 12B.

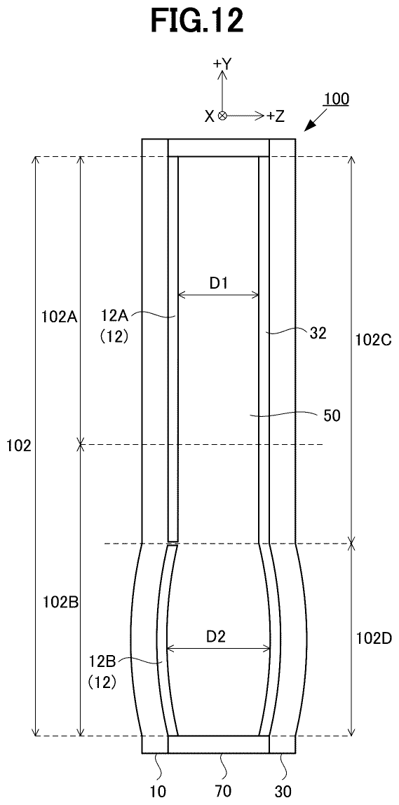

As illustrated in FIGS. 11 and 12, the first driving electrodes 12A of the present embodiment extend along the Y-axis direction, and are disposed in a ⅔ region 102C positioned on the vertically upward side in the variable region 102 that includes the upper region 102A. The second driving electrodes 12B of the present embodiment extend along the Y-axis direction, and are disposed in a ⅓ region 102D positioned on the vertically downward side in the variable region 102. A region 102D corresponds to a ⅔ region positioned on the vertically downward side in the lower region 102B.

In a case in which the optical panel 100 is installed with the front surface 101 perpendicular to the ground surface, depending on the material of the first light-transmitting substrate 10 and the second light-transmitting substrate 30, the thickness of the liquid crystal 50, and the like, the thickness of the liquid crystal 50 in a narrow region on the vertically downward side in the lower region 102B may increase. As such, in the present embodiment, a voltage, higher than the voltage applied by the common electrode 32 and the first driving electrodes 12A to the liquid crystal 50 of the region 102C, is applied by the common electrode 32 and the second driving electrodes 12B to the liquid crystal 50 of the region 102D. As a result, as with the upper region 102A and the lower region 102B in Embodiment 1, it is possible to suppress inconsistencies in the optical characteristics (inconsistencies of the retardation R) of the region 102C and the region 102D.

### Embodiment 3

In Embodiment 1 and Embodiment 2, the first light-transmitting substrate 10 and the second light-transmitting substrate 30 sandwich the liquid crystal 50. However, a configuration is possible in which the first light-transmitting substrate 10 and the second light-transmitting substrate 30 sandwich an electrophoretic medium.

As with the optical panel 100 of Embodiment 1, an optical panel 100 of the present embodiment is installed with a front surface 101 perpendicular to the ground surface. Additionally, as with the optical panel 100 of Embodiment 1, the optical panel 100 of the present embodiment includes a variable region 102 and a surrounding region 104. The optical panel 100 of the present embodiment includes a first light-transmitting substrate 10 and a second light-transmitting substrate 30. Instead of the liquid crystal 50, the optical panel 100 of the present embodiment includes an electrophoretic medium 80 including a light-transmitting dispersion medium 82 and electrophoretic particles 84.

In the present embodiment, the variable region 102 varies between a state in which light is blocked throughout the entire surface, and a state in which a region that blocks light and a region that transmits light occur throughout the entire surface. That is, the optical panel 100 of the present embodiment functions as a light control element. In the present embodiment, the state in which light is blocked throughout the entire surface is referred to as a “first state”, and the state in which a region that blocks light and a region that transmits light occur throughout the entire surface is referred to as a “second state.”

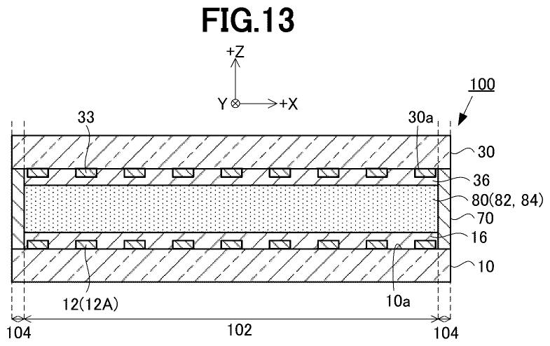

As with the first light-transmitting substrate 10 of Embodiments 1 and 2, the first light-transmitting substrate 10 of the present embodiment transmits visible light. As illustrated in FIG. 13, the first light-transmitting substrate 10 of the present embodiment includes a plurality of driving electrodes 12, and an insulating layer 16.

As with the driving electrodes 12 of Embodiment 2, each of the driving electrodes 12 of the present embodiment has a rectangular shape and extends along the Y-axis direction. Additionally, the driving electrodes 12 of the present embodiment are disposed in the variable region 102 at a predetermined spacing in the X-axis direction. Furthermore, as in Embodiment 2, the driving electrodes 12 are divided into two sections, first driving electrodes 12A and second driving electrodes 12B. The first driving electrodes 12A are disposed in the region 102C and the second driving electrodes 12B are disposed in the region 102D (FIG. 11). In the present embodiment as well, the first driving electrodes 12A and the second driving electrodes 12B are each connected to a controller 310 via a non-illustrated wiring. The driving electrodes 12 of the present embodiment are formed from a metal such as aluminum (Al), molybdenum (Mo), or the like.

The insulating layer 16 is provided on a main surface 10a, the first driving electrodes 12A, and the second driving electrodes 12B. In one example, the insulating layer 16 is formed from silicon oxide (SiO₂).

As with the second light-transmitting substrate 30 of Embodiments 1 and 2, the second light-transmitting substrate 30 of the present embodiment transmits visible light. The second light-transmitting substrate 30 faces the first light-transmitting substrate 10. The second light-transmitting substrate 30 is affixed to the first light-transmitting substrate 10 by a sealing material 70. The second light-transmitting substrate 30 and the first light-transmitting substrate 10 sandwich the electrophoretic medium 80. As illustrated in FIG. 13, the second light-transmitting substrate 30 of the present embodiment includes a plurality of counter electrodes 33, and an insulating layer 36.

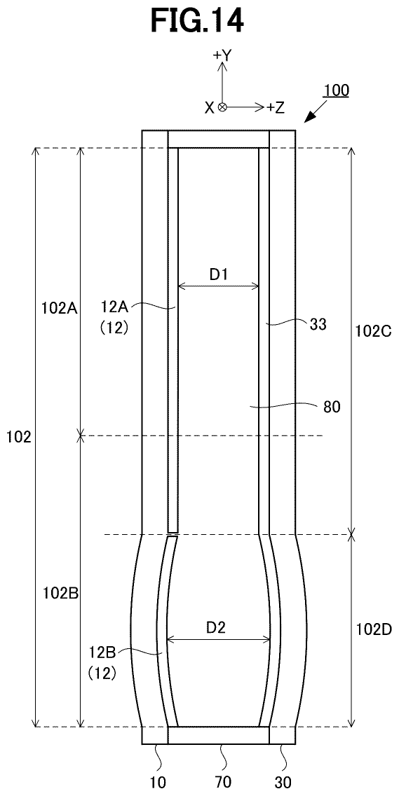

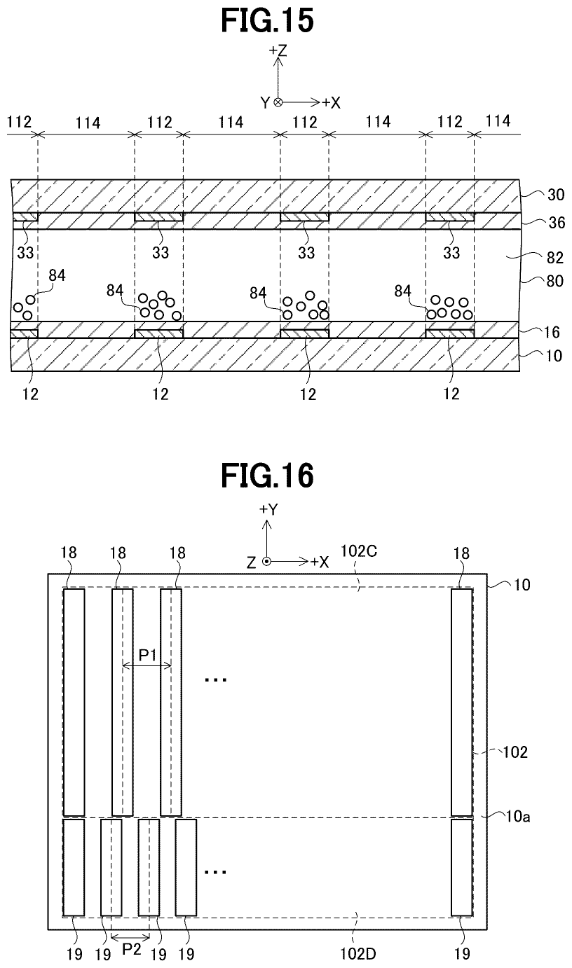

As illustrated in FIGS. 13 and 14, each of the counter electrodes 33 has a rectangular shape and extends in the Y-axis direction. In the present embodiment, one of the counter electrodes 33 faces one of the driving electrodes 12 (a first driving electrode 12A and a second driving electrode 12B obtained by dividing one of the driving electrodes 12). The counter electrodes 33 are formed from a metal such as aluminum (Al), molybdenum (Mo), or the like. The counter electrodes 33 are connected to the controller 310.

The insulating layer 36 is provided on a main surface 30a of the second light-transmitting substrate 30, and on the counter electrodes 33. In one example, the insulating layer 36 is formed from silicon oxide (SiO₂).

The electrophoretic medium 80 is sandwiched between the first light-transmitting substrate 10 and the second light-transmitting substrate 30. The electrophoretic medium 80 includes the light-transmitting dispersion medium 82 and the electrophoretic particles 84.

The light-transmitting dispersion medium 82 transmits visible light. The light-transmitting dispersion medium 82 disperses the electrophoretic particles 84.

The electrophoretic particles 84 are dispersed in the light-transmitting dispersion medium 82 and absorb visible light. The electrophoretic particles 84 are positively or negatively charged. A dispersion state of the electrophoretic particles 84 in the light-transmitting dispersion medium 82 varies in accordance with voltage applied from the first driving electrodes 12A or the second driving electrodes 12B, and the counter electrodes 33. In one example, the electrophoretic particles 84 are implemented as charged carbon black particles. In the present embodiment, it is assumed that the electrophoretic particles 84 are negatively charged.

Next, operations of the optical panel 100 of the present embodiment are described. The optical panel 100 of the present embodiment functions as a light control element due to variations in the dispersion state of the electrophoretic particles 84.

In one example, when the potential of the driving electrodes 12 (the first driving electrodes 12A and the second driving electrodes 12B) of the first light-transmitting substrate 10 and the potential of the counter electrodes 33 of the second light-transmitting substrate 30 are set by the controller 310 to the same potential, the electrophoretic particles 84 that absorb visible light are dispersed uniformly throughout the entire variable region 102. Accordingly, the variable region 102 of the optical panel 100 of the present embodiment absorbs visible light and is in a state (specifically, the first state) in which visible light is blocked throughout the entire surface.

Meanwhile, when the potential of the driving electrodes 12 (the first driving electrodes 12A and the second driving electrodes 12B) of the first light-transmitting substrate 10 is set higher than the potential of the counter electrodes 33 of the second light-transmitting substrate 30, as illustrated in FIG. 15, the electrophoretic particles 84 gather to the driving electrodes 12 (the first driving electrodes 12A or the second driving electrodes 12B). As a result, a region 112 that blocks visible light in which the electrophoretic particles 84 have gathered to the driving electrodes 12, and a region 114 that transmits visible light occur. Accordingly, the variable region 102 of the optical panel 100 of the present embodiment assumes a state (specifically, the second state) in which the region 112 that blocks visible light and the region 114 that transmits visible light occur throughout the entire surface.

The optical panel 100 of the present embodiment also is installed with a front surface 101 including the variable region 102 perpendicular to the ground surface. Due to this, the electrophoretic medium 80 (the light-transmitting dispersion medium 82 and the electrophoretic particles 84) are biased to the region vertically downward in the variable region 102 (in the present embodiment, the region 102D), and the thickness (cell thickness) D2 of the electrophoretic medium 80 of the vertically downward region (the region 102D) becomes greater than the thickness D1 of the electrophoretic medium 80 of the upper region 102A.

When mobility is μ, electric field strength (voltage per unit distance) is E, effective charge is Q, the radius of the electrophoretic particles 84 is r, the viscosity of the light-transmitting dispersion medium 82 is η, applied voltage is V, and a distance between the driving electrodes 12 and the counter electrodes 33 is L, a movement speed v of the electrophoretic particles 84 is expressed by Equation (1) below.

$$v = μ \times E = ( \frac{Q}{6 \times π \times η \times r} ) \times ( \frac{V}{L} ) \qquad ( 1 )$$

When the thickness (cell thickness) of the electrophoretic medium 80 increases, the distance L between the driving electrodes 12 and the counter electrodes 33 increases and, based on Equation (1), the movement speed v of the electrophoretic particles 84 decreases. Accordingly, when the same voltage is applied to the electrophoretic medium 80 of the region 102C and the electrophoretic medium 80 of the region 102D, the movement of the electrophoretic particles 84 in the region 102D is slower than the movement of the electrophoretic particles 84 in the region 102C. This causes a difference to occur, between the region 102C and the region 102D, in response times of transitioning from the first state to the second state.

In the present embodiment, a voltage, higher than the voltage applied by the counter electrodes 33 and the first driving electrodes 12A to the electrophoretic medium 80 of the region 102C, is applied by the counter electrodes 33 and the second driving electrodes 12B to the electrophoretic medium 80 of the region 102D. As a result, it is possible to suppress the difference in the response times (response characteristic inconsistencies) of the region 102C and the region 102D. As an example, when the thickness D1 of the region 102C (the upper region 102A) is set to 25 μm and the thickness D2 of the region 102D is set to 30 μm, the difference in the response times of the region 102C and the region 102D can be suppressed by applying 24.0 V to the electrophoretic medium 80 of the region 102C and 28.8 V to the electrophoretic medium 80 of the region 102D.

### Embodiment 4

In Embodiment 3, the driving electrodes 12 (the first driving electrodes 12A and the second driving electrodes 12B) and the counter electrodes 33 are arranged in the X-axis direction at the same arrangement pitch, and apply voltage to the electrophoretic medium 80. However, a configuration is possible in which the arrangement pitch at which the driving electrodes 12 and the counter electrodes 33 disposed in the region 102C are arranged in the X-axis direction, and the arrangement pitch at which the driving electrodes 12 and the counter electrodes 33 disposed in the region 102D are arranged in the X-axis direction differ.

As with the optical panel 100 of Embodiment 3, an optical panel 100 of the present embodiment is installed with a front surface 101 perpendicular to the ground surface. Additionally, as with the optical panel 100 of Embodiment 3, the optical panel 100 of the present embodiment includes a variable region 102 and a surrounding region 104. The optical panel 100 of the present embodiment includes a first light-transmitting substrate 10, a second light-transmitting substrate 30, and an electrophoretic medium 80. The optical panel 100 of the present embodiment functions as a light control element.

The configuration of the optical panel 100 of the present embodiment is the same as the optical panel 100 of Embodiment 3, except that the first light-transmitting substrate 10 includes third driving electrodes 18 and fourth driving electrodes 19 instead of the driving electrodes 12 (the first driving electrodes 12A and the second driving electrodes 12B), and the second light-transmitting substrate 30 includes third counter electrodes 38 and fourth counter electrodes 39 instead of the counter electrodes 33. Here, the third driving electrodes 18 and the fourth driving electrodes 19 of the first light-transmitting substrate 10, and the third counter electrodes 38 and the fourth counter electrodes 39 of the second light-transmitting substrate 30 are described.

As illustrated in FIG. 16, the third driving electrodes 18 of the first light-transmitting substrate 10 are provided on the main surface 10a of the first light-transmitting substrate 10. Each of the third driving electrodes 18 has a rectangular shape and extends along the Y-axis direction. The third driving electrodes 18 are disposed in the region 102C and are arranged in the X-axis direction at a predetermined first arrangement pitch P1.

As with the third driving electrodes 18, the fourth driving electrodes 19 of the first light-transmitting substrate 10 are provided on the main surface 10a of the first light-transmitting substrate 10, and extend along the Y-axis direction. The fourth driving electrodes 19 are disposed in the region 102D. The fourth driving electrodes 19 are arranged in the X-axis direction at a predetermined second arrangement pitch P2 that is narrower than the first arrangement pitch P1 of the third driving electrodes 18.

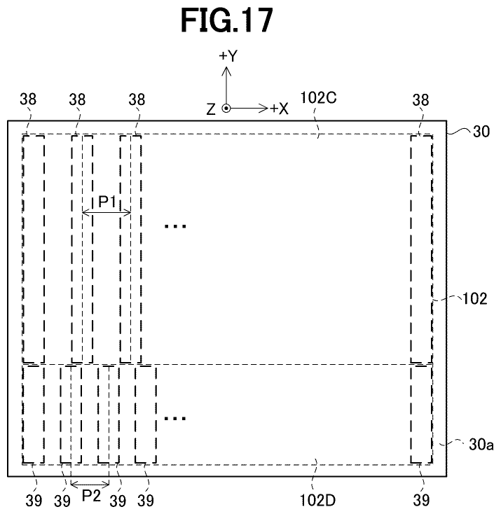

As illustrated in FIG. 17, the third counter electrodes 38 of the second light-transmitting substrate 30 are provided on a main surface 30a of the second light-transmitting substrate 30. Each of the third counter electrodes 38 has a rectangular shape and extends along the Y-axis direction. The third counter electrodes 38 are arranged, in the region 102C, in the X-axis direction at an arrangement pitch identical to the first arrangement pitch P1 of the third driving electrodes 18. Each of the third counter electrodes 38 faces each of the third driving electrodes 18.

As with the third counter electrodes 38, the fourth counter electrodes 39 of the second light-transmitting substrate 30 are provided on the main surface 30a of the second light-transmitting substrate 30, and extend along the Y-axis direction. The fourth counter electrodes 39 are arranged, in the region 102D, in the X-axis direction at an arrangement pitch identical to the second arrangement pitch P2 of the fourth driving electrodes 19. Each of the fourth counter electrodes 39 faces each of the fourth driving electrodes 19.

In the present embodiment, the second arrangement pitch P2 of the fourth driving electrodes 19 and the fourth counter electrodes 39 disposed in the region 102D is narrower than the first arrangement pitch P1 of the third driving electrodes 18 and the third counter electrodes 38 disposed in the region 102C. Due to this, even when the voltage applied to the electrophoretic medium 80 by the third driving electrodes 18 and the third counter electrodes 38 and the voltage applied to the electrophoretic medium 80 by the fourth driving electrodes 19 and the fourth counter electrodes 39 are the same, the strength of the electrical field acting on the thick electrophoretic medium 80 of the region 102D can be brought close to the strength of the electrical field acting on the thin electrophoretic medium 80 of the region 102C, and the difference in the response times of the region 102C and the region 102D (response characteristic inconsistencies) can be suppressed.

### MODIFIED EXAMPLES

Embodiments have been described, but various modifications can be made to the present disclosure without departing from the spirit and scope of the present disclosure.

In Embodiments 1 to 4, the optical panel 100 is installed with the front surface 101 perpendicular to the ground surface. However, it is sufficient that the optical panel 100 is installed with the front surface 101 inclined with respect to the ground surface.

In Embodiment 1, a voltage, higher than the voltage applied to the liquid crystal 50 of the upper region 102A, is applied to the liquid crystal 50 of the lower region 102B. Additionally, in Embodiments 2 and 3, a voltage, higher than the voltage applied to the liquid crystal 50 or the electrophoretic medium 80 of the upper region 102A, is applied to the liquid crystal 50 or the electrophoretic medium 80 of the region 102D (the ⅔ region positioned on the vertically downward side in the lower region 102B). However, in the optical panel 100, it is sufficient that, in accordance with the thickness of the liquid crystal 50 or the electrophoretic medium 80 of the lower region 102B, a voltage, higher than the voltage applied to the liquid crystal 50 or the electrophoretic medium 80 of the upper region 102A, is applied to the liquid crystal 50 or the electrophoretic medium 80 of at least a partial region of the lower region 102B.

A configuration is possible in which the optical panel 100 of Embodiment 3 does not include the insulating layers 16 and 36.

In Embodiment 4, the second arrangement pitch P2 of the fourth driving electrodes 19 and the fourth counter electrodes 39 disposed in the region 102D is narrower than the first arrangement pitch P1 of the third driving electrodes 18 and the third counter electrodes 38 disposed in the region 102C. However, with the optical panel 100, it is sufficient that, in accordance with the thickness of the electrophoretic medium 80 of the lower region 102B, the arrangement pitch of the driving electrodes disposed in at least a partial region of the lower region 102B is narrower than the arrangement pitch of the driving electrodes disposed in the upper region 102A.

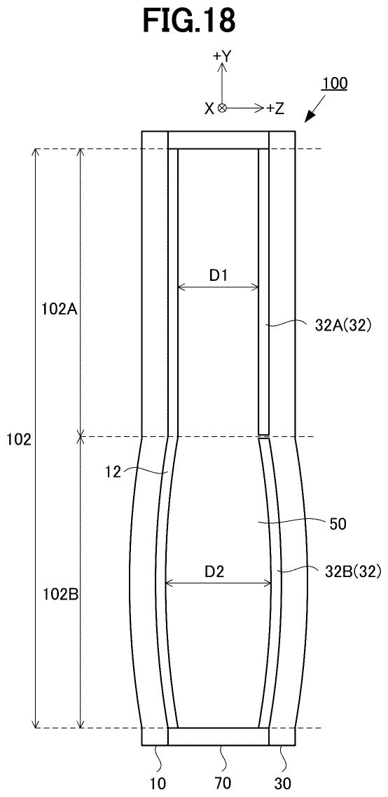

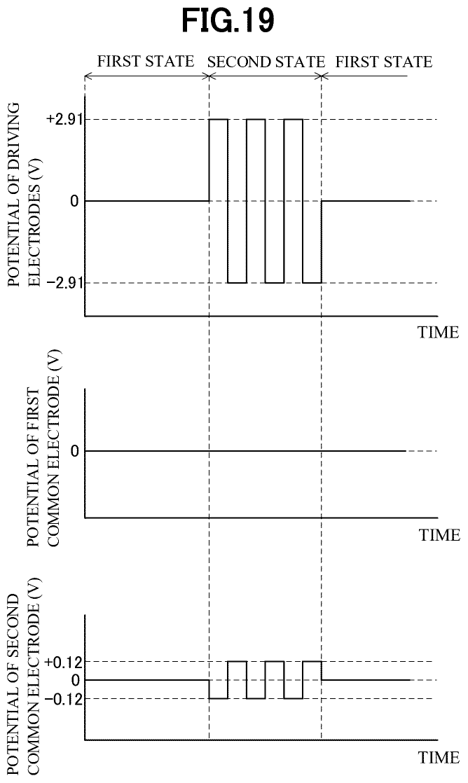

In Embodiments 1 to 3, the driving electrodes 12 are divided into the first driving electrode 12A and the second driving electrode 12B. In the optical panel 100 of Embodiments 1 and 2, a configuration is possible in which the common electrode 32 is divided into two sections, and the driving electrodes 12 are not divided. As illustrated in FIG. 18, for example, a configuration is possible in which the first light-transmitting substrate 10 includes driving electrodes 12 that are not divided, and the second light-transmitting substrate 30 includes common electrodes 32 that are divided into a first common electrode 32A positioned in the upper region 102A and a second common electrode 32B positioned in the lower region 102B. In such a case, as illustrated in FIG. 19, a voltage, higher than the voltage applied to the liquid crystal 50 of the upper region 102A, may be applied to the liquid crystal 50 of the lower region 102B by setting the potential of the first common electrode 32A to zero, and inverting the potential of the second common electrode 32B with respect to the potential of the driving electrodes 12.

Additionally, in Embodiment 3, a configuration is possible in which the counter electrodes 33 are divided into two sections, and the driving electrodes 12 are not divided.

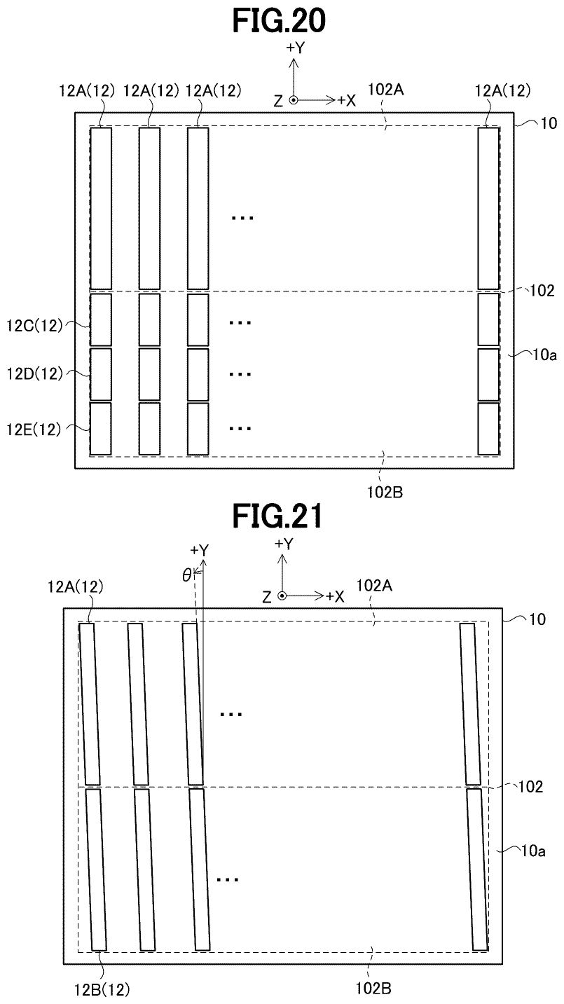

A configuration is possible in which the driving electrodes 12 are divided into three or more sections. As illustrated in FIG. 20, for example, a configuration is possible in which the driving electrodes 12 are divided into four sections, the first driving electrodes 12A are disposed in the upper region 102A of the first light-transmitting substrate 10, and driving electrodes 12C to 12E are disposed in the lower region 102B of the first light-transmitting substrate 10. In such a case, it is sufficient that, in accordance with the thickness of the liquid crystal 50 or the electrophoretic medium 80, mutually different voltages, higher than the voltage applied to the liquid crystal 50 or the electrophoretic medium 80 of the upper region 102A, are applied to the liquid crystal 50 or the electrophoretic medium 80 of the regions corresponding to each of the driving electrodes 12C to 12E. Such a configuration makes it possible to further suppress inconsistencies of the optical characteristics or inconsistencies of the response times of the optical panel 100.

Furthermore, a configuration is possible in which the common electrode 32 or the counter electrodes 33 are divided into three or more sections. Such a configuration makes it possible to further suppress inconsistencies of the optical characteristics or inconsistencies of the response times of the optical panel 100.

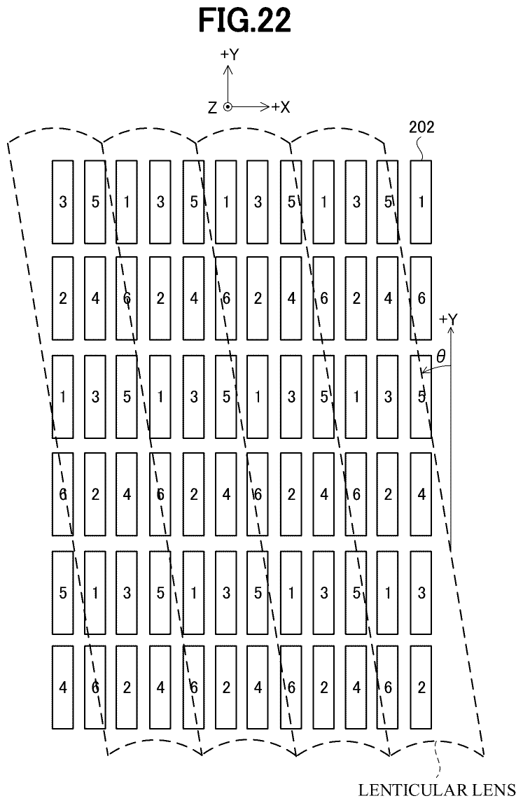

The direction in which the electrodes such as the driving electrodes 12 (the first driving electrodes 12A and the second driving electrodes 12B), the third driving electrodes 18, and the like extend can be set as desired. For example, a configuration is possible in which, in the optical panel 100 of Embodiment 1, the driving electrodes 12 (the first driving electrodes 12A and the second driving electrodes 12B) are inclined counter-clockwise at an angle θ with respect to the Y-axis direction, as illustrated in FIG. 21. In such a case, the optical panel 100 that includes the liquid crystal 50 functions as a lenticular lens array, such as illustrated in FIG. 22, in which the lenticular lens is inclined at the angle θ with respect to the arrangement direction (the Y-axis direction) of pixels (viewpoint pixels displaying a plurality of viewpoint images) 202 of the liquid crystal display panel 200. Due to this, the optical panel 100 can distribute, in different directions, not only the display light from the pixels 202 arranged in the X-axis direction, but also the display light from the pixels 202 arranged in the Y-axis direction. In the example illustrated in FIG. 22, viewpoint images can be presented in six directions. In FIG. 22, the number attached to each of the pixels 202 indicates the number of the viewpoint image.

In Embodiment 1, the display device 300 displays two-dimensional images and three-dimensional images. However, a configuration is possible in which the display device 300 is a multi-screen display device that presents, by a lenticular lens array, different images to observers located at different positions.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An optical panel, comprising:
a first light-transmitting substrate;
a second light-transmitting substrate facing the first light-transmitting substrate;
a liquid crystal or an electrophoretic medium including a light-transmitting dispersion medium and electrophoretic particles, sandwiched between the first light-transmitting substrate and the second light-transmitting substrate, wherein
a front surface including a variable region, in which an optical characteristic varies between two states throughout an entire surface, is installed inclined with respect to a ground surface,
in an installed state, the variable region is bisected into an upper region positioned vertically upward, and a lower region positioned vertically downward, and
in a case of applying a voltage to the liquid crystal or the electrophoretic medium to set the variable region to one state of the two states,
a voltage, higher than a voltage applied to the liquid crystal or the electrophoretic medium of the upper region, is applied to the liquid crystal or the electrophoretic medium of at least a partial region of the lower region.

2. The optical panel according to claim 1, wherein
in a case of applying a voltage to the liquid crystal or the electrophoretic medium to set the variable region to one state of the two states,
a voltage, higher than the voltage applied to the liquid crystal or the electrophoretic medium of the upper region, is applied to the liquid crystal or the electrophoretic medium of a ⅔ region positioned on a vertically downward side in the lower region.

3. The optical panel according to claim 1, wherein
the electrophoretic medium is sandwiched between the first light-transmitting substrate and the second light-transmitting substrate,
in the one state of the variable region, light is transmitted, and
in another state of the two states of the variable region, light is blocked.

4. The optical panel according to claim 1, wherein
the liquid crystal is sandwiched between the first light-transmitting substrate and the second light-transmitting substrate, and
in the one state of the variable region, a refractive index distribution of the liquid crystal varies at a predetermined cycle along a direction parallel to the ground surface.

5. The optical panel according to claim 1, further comprising:
a driving electrode and a common electrode that apply the voltage to the liquid crystal or the electrophoretic medium, wherein
the driving electrode or the common electrode is divided in accordance with a position of the region in which the voltage, higher than the voltage applied to the liquid crystal or the electrophoretic medium of the upper region, is applied to the liquid crystal or the electrophoretic medium.

6. An optical panel comprising:
an electrophoretic medium including a light-transmitting dispersion medium and electrophoretic particles;
a first light-transmitting substrate and a second light-transmitting substrate sandwiching the electrophoretic medium; and,
a plurality of electrodes that applies a voltage to the electrophoretic medium, wherein
a front surface including a variable region, in which an optical characteristic varies between two states throughout an entire surface, is installed inclined with respect to a ground surface,
in an installed state, the variable region is bisected into an upper region positioned vertically upward, and a lower region positioned vertically downward, and
an arrangement pitch, of the electrodes disposed in at least a partial region of the lower region, is narrower than an arrangement pitch of the electrodes disposed in the upper region.

7. The optical panel according to claim 6, wherein an arrangement pitch, of the electrodes disposed in a ⅔ region positioned on a vertically downward side in the lower region, is narrower than the arrangement pitch of the electrodes disposed in the upper region.

8. The optical panel according to claim 6, wherein
in one state of the two states of the variable region, light is transmitted, and
in another state of the two states of the variable region, light is blocked.
